(19) United States
(12) Patent Application Publication
(10) Pub. No.: US 2019/0379566 A1
(43) Pub. Date: Dec. 12, 2019

(54) BASE STATION, MOBILE STATION, METHOD OF CONTROLLING BASE STATION, AND RECORDING MEDIUM

(71) Applicant: NEC CORPORATION, Tokyo (JP)

(72) Inventors: Kenji KOYANAGI, Tokyo (JP); Tsuguo MARU, Tokyo (JP)

(73) Assignee: NEC CORPORATION, Tokyo (JP)

(21) Appl. No.: 16/478,671

(22) PCT Filed: Jan. 15, 2018
(86) PCT No.: PCT/JP2018/000835

§ 371 Date: Jul. 17, 2019

(30) Foreign Application Priority Data
Jan. 19, 2017 (JP) 2017-007205

(51) Int. Cl. H04L 27/26; H04L 5/00

(52) U.S. Cl. CPC H04L 27/2607; H04L 5/0048; H04L 5/0044; H04L 27/2628

(57) ABSTRACT

In order to provide a new mechanism capable of reducing an interference caused by a multipath delay, a base station includes a processor and a transmitter. The processor generates a first modulation symbol from transmission data, converts the first modulation symbol from a frequency domain signal to a first valid symbol being a time domain signal by performing inverse Fourier transform for the first modulation symbol, inserts a first guard interval into the first valid symbol, and outputs the inserted signal as a first orthogonal frequency division multiplexing (OFDM) symbol. The transmitter transmits a first OFDM signal generated based on the first OFDM symbol. The processor leaves blank at least one of a second OFDM symbol adjacent to the first OFDM symbol or at least one of a plurality of subcarriers configuring the first valid symbol.

### TECHNICAL FIELD

The present invention relates to a base station, a mobile station, a method for controlling a base station, and a recording medium.

### BACKGROUND ART

In a wireless communication system, a multicarrier transmission system using, for example, orthogonal frequency division multiplex (OFDM) can reduce an influence of multipath fading in high-speed digital signal transmission via multicarrier achievement and by inserting a guard interval (GI) (see PTL 1). However, when in OFDM, a delay wave (delay path) having a delay time that exceeds a guard interval section exists, an inter symbol interference (ISI) caused by entrance of an anterior symbol into a fast Fourier transform (FFT) section and an inter-carrier interference (ICI) caused by entrance of a break of a symbol, i.e., a discontinuous section of a signal into a fast Fourier transform section occur, resulting in a cause of characteristic degradation.

### CITATION LIST

### Patent Literature

[PTL 1] Japanese Unexamined Patent Application Publication No. 2002-374223

### SUMMARY OF INVENTION

### Technical Problem

Therefore, an example embodiment is proposed in order to solve the problem of the background art described above, and an object thereof is to provide a new mechanism capable of reducing an interference caused by a multipath delay.

### Solution to Problem

A base station in the example embodiment includes a processor and a transmitter. The processor generates a first modulation symbol from transmission data, converts the first modulation symbol from a frequency domain signal to a first valid symbol being a time domain signal by performing inverse Fourier transform for the first modulation symbol, inserts a first guard interval into the first valid symbol, and outputs the inserted signal as a first orthogonal frequency division multiplexing (OFDM) symbol. Further, the transmitter transmits a first OFDM signal generated based on the first OFDM symbol. The processor leaves blank at least one of a second OFDM symbol adjacent to the first OFDM symbol or at least one of a plurality of subcarriers configuring the first valid symbol.

A mobile station in another example embodiment includes a receiver and a processor. The receiver receives a first orthogonal frequency division multiplexing (OFDM) signal generated based on a first OFDM symbol. The processor generates a first valid symbol by eliminating a first guard interval from the first OFDM symbol, converts the first valid symbol being a time domain signal to a frequency domain signal by performing Fourier transform for the first valid symbol, and generates transmission data by executing demodulation processing, based on the frequency domain signal. At least one of a second OFDM symbol adjacent to the first OFDM symbol or at least one of a plurality of subcarriers configuring the first valid symbol is blank.

A method for controlling a base station in another example embodiment includes: generating a first modulation symbol from transmission data; converting the first modulation symbol from a frequency domain signal to a first valid symbol being a time domain signal by performing inverse Fourier transform for the first modulation symbol; inserting a first guard interval into the first valid symbol; outputting the inserted signal as a first orthogonal frequency division multiplexing (OFDM) symbol; transmitting a first OFDM signal generated based on the first OFDM symbol; and leaving blank at least one of a second OFDM symbol adjacent to the first OFDM symbol or at least one of a plurality of subcarriers configuring the first valid symbol.

A program recorded on an non-transitory computer-readable recording medium in another example embodiment causes a computer to execute to generate a first modulation symbol from transmission data; convert the first modulation symbol from a frequency domain signal to a first valid symbol being a time domain signal by performing inverse Fourier transform for the first modulation symbol; insert a first guard interval into the first valid symbol; output the inserted signal as a first orthogonal frequency division multiplexing (OFDM) symbol; transmit a first OFDM signal generated based on the first OFDM symbol; and leaving blank at least one of a second OFDM symbol adjacent to the first OFDM symbol or at least one of a plurality of subcarriers configuring the first valid symbol.

### Advantageous Effects of Invention

The example embodiment is able to provide a new mechanism capable of reducing an interference caused by a multipath delay.

### BRIEF DESCRIPTION OF DRAWINGS

FIG. 1 shows a mobile communication system according to an example embodiment.

FIG. 2 shows one example of a transmission signal according to the example embodiment.

FIG. 3 shows one example of a transmission signal according to the example embodiment.

FIG. 4 shows one example of a transmission signal according to the example embodiment.

FIG. 5 shows one example of a transmission signal according to a first example embodiment.

FIG. 6 shows a base station of the first example embodiment.

FIG. 7 shows a mobile station of the first example embodiment.

FIG. 8 shows a mobile station of a second example embodiment.

FIG. 9 shows one example of a reception signal according to the second example embodiment.

FIG. 10 shows an outline of an operation of the mobile station according to the second example embodiment.

FIG. 11 shows an outline of an operation of the mobile station according to the second example embodiment.

FIG. 12 shows one example of a transmission signal according to a third example embodiment.

FIG. 13 shows a base station according to a fourth example embodiment.

FIG. 14 shows a plurality of base stations according to a fifth example embodiment.

FIG. 15 shows an operation flowchart according to the fifth example embodiment.

FIG. 16 shows a base station according to a sixth example embodiment.

FIG. 17 shows one example of a reception wave being a synthesized wave of a direct wave and a delay wave according to the sixth example embodiment.

FIG. 18 shows a base station according to a seventh example embodiment.

FIG. 19 shows a mobile station according to the seventh example embodiment.

### EXAMPLE EMBODIMENT

Example embodiments are described in detail with reference to the drawings. In the drawings, the same or a corresponding element is assigned with the same sign, and for description clarification, redundant description is omitted as necessary.

A plurality of example embodiments to be described below can be carried out independently or can be carried out by appropriately combining these example embodiments.

### Introduction

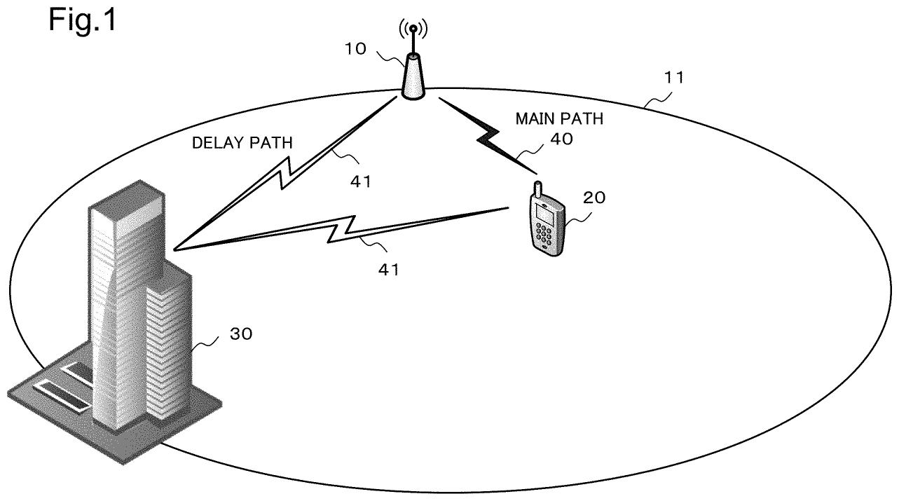

FIG. 1 illustrates a mobile communication system according to an example embodiment. The mobile communication system includes at least one base station 10 and one mobile station 20. The base station 10 manages at least one cell 11.

In FIG. 1, an example in which the base station 10 communicates with the mobile station 20 existing in the cell 11 is illustrated. In this example, the base station 10 communicates with the mobile station 20 via a main path 40. Further, the base station 10 communicates with the mobile station 20 via a delay path 41. A radio wave transmitted from the base station 10 is reflected on a reflective object 30 via the delay path 41. A reflected radio wave arrives at the mobile station 20 via the delay path 41.

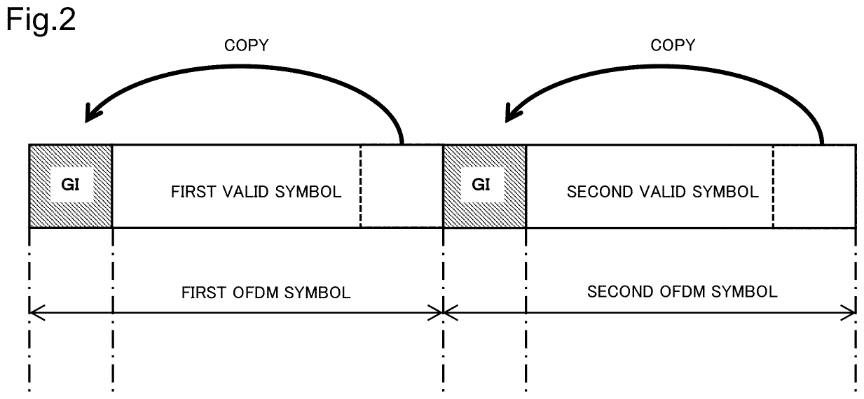

FIG. 2 illustrates one example of a transmission signal according to the example embodiment. In FIG. 2, an outline of a signal arriving from a transmission device (base station) to a reception device (mobile station) through a multipath environment is illustrated.

In FIG. 2, a horizontal direction represents a time and indicates that signals are sequentially transmitted from a left side to a right side. Therefore, the left side of the figure may be referred to as a front, a front side, a forward, or the like and the right side of the figure may be referred to as a back, a back side, a backward or the like. The same applies to other figures.

In FIG. 2, an orthogonal frequency division multiplexing (OFDM) symbol includes a valid symbol and a guard interval (GI) (or a cyclic prefix (CP)) that is a signal disposed at a head of the valid symbol by duplicating a last half of the valid symbol. A guard interval may be a signal added, by duplicating a valid symbol, to an end of the valid symbol. Hereinafter, in the present description, for convenience, a signal added to a head is referred to as a guard interval (GI) and a signal added to an end is referred to as a cyclic prefix (CP).

On a reception device side, a signal having the same length as a GI is eliminated from an OFDM symbol, and thereby only a valid symbol is cut out and reception processing is executed.

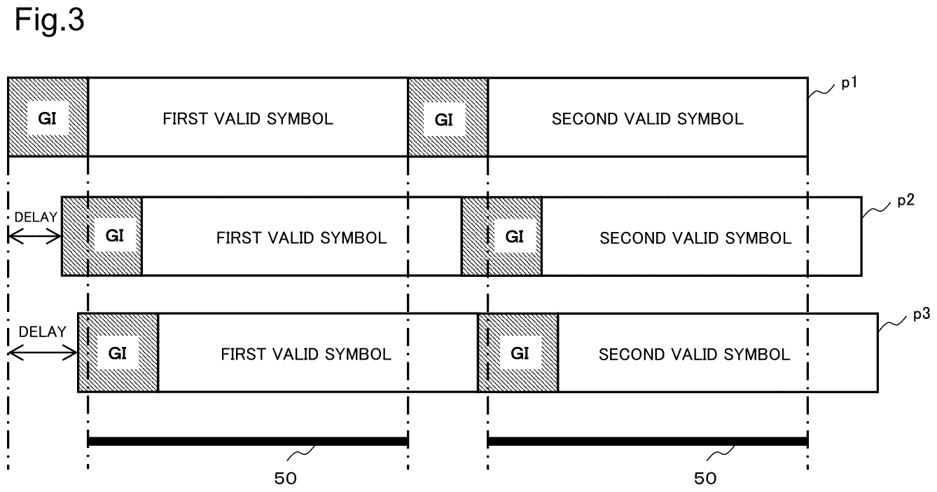

FIG. 3 illustrates one example of a transmission signal according to the example embodiment. In the example illustrated in FIG. 3, when a carrier wave (a main path, a direct wave, p1) arriving first and a carrier wave (a delay path, a delay wave, p2, p3) subjected to propagation delay as a result of passing through a different path due to reflection or the like are synchronized with the main path p1 and FFT processing is executed in a sampling section (an FFT section 50) being a section excluding a GI of the main path p1, delay times of a delay path p2 and a delay path p3 fall within a guard interval section.

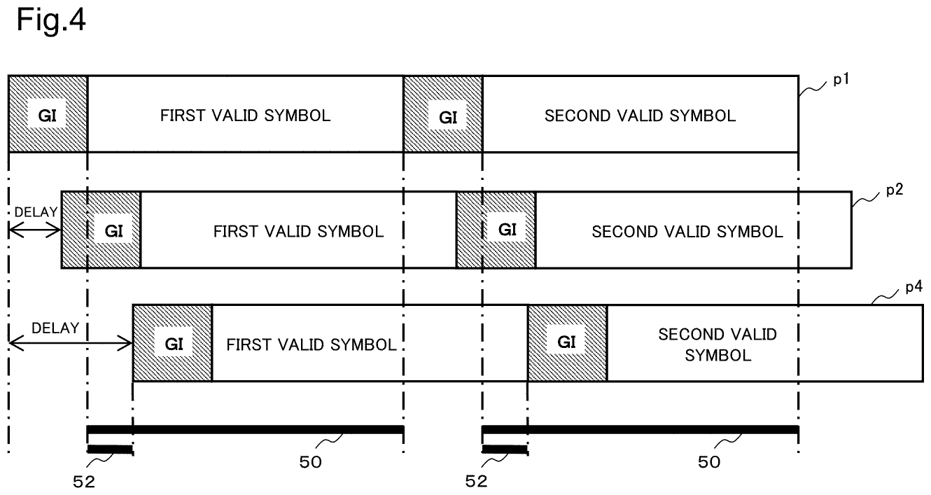

FIG. 4 illustrates one example of a transmission signal according to the example embodiment. In FIG. 4, a delay time of a delay path p2 falls within a guard interval section. On the other hand, in a delay path p4, a delay exceeding a guard interval section occurs.

With regard to such a delay wave p4 in which a delay exceeding a guard interval section occurs, a part of an anterior OFDM symbol (an immediately anterior OFDM symbol) of a desired OFDM symbol enters an FFT section 50. Therefore, FFT processing is executed for the delay wave p4 including a part 52 of the immediately anterior OFDM symbol. In other words, an inter-symbol interference (ISI) occurs.

Further, in the delay wave p4 in which a delay exceeding a guard interval section occurs, a break, i.e., a discontinuous section of a signal is inserted between a desired OFDM symbol and an intermediately anterior OFDM symbol in the FFT section 50. Therefore, FFT processing is executed for the delay wave p4 including a discontinuous section of a signal. In other words, an inter-carrier interference (ICI) occurs.

In this manner, in a reception device, when a signal of a last symbol is mixed, signal determination of “0” or “1” is prohibited.

In Long Term Evolution (LTE), for example, a frame format such as a GI length and a data symbol length is defined. A GI length is designed, assuming that a cell radius is approximately several km at a maximum level.

On the other hand, in a wireless communication system (e.g., a private wireless system) other than LTE, a cell radius may exceed 10 km. When an LTE system is used as-is for a private wireless system, a maximum delay time exceeds a GI length, resulting in a possibility of occurrence of an inter-symbol interference.

This problem can be solved by reducing a cell radius. However, when a cell radius is reduced, a large number of base stations are required in order to cover a communication area and therefore a cost of a base station and base station installation increases.

Further, as in the method described in PTL 1, a method for adaptively modifying a GI length according to a maximum delay is conceivable, but in this case, it is difficult to use an existing LTE terminal and base station and therefore a development cost for an entire communication system is required.

The following example embodiments use, for example, a frame format of LTE and provide a new mechanism for reducing an interference caused by a multipath delay.

### First Example Embodiment

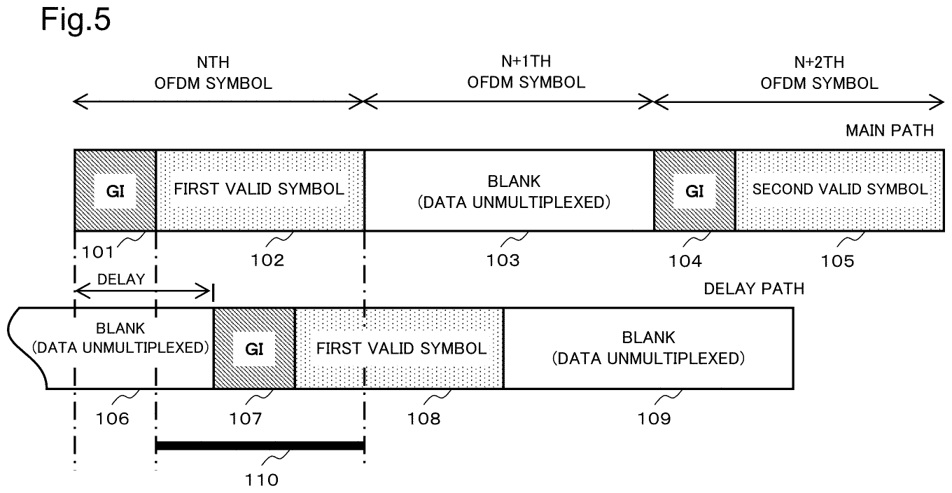

FIG. 5 is a diagram illustrating an outline of a signal arriving from a transmission device (a base station) to a reception device (a mobile station) through a multipath environment.

In the present example embodiment, an existing LTE frame format is used as-is. A frame format of the present example embodiment alternately includes an OFDM symbol in which data are multiplexed and a (blank) OFDM symbol in which data are not multiplexed.

In the example illustrated in FIG. 5, in an Nth OFDM symbol and an N+2th OFDM symbol, data are multiplexed. On the other hand, in an N+1th OFDM symbol, data are not multiplexed.

An Nth OFDM symbol of a main path includes a first valid symbol 102 and a GI 101. An N+1th OFDM symbol adjacent to the Nth OFDM symbol is a blank symbol 103 being a symbol in which data are not multiplexed. An N+2th OFDM symbol adjacent to the N+1th OFDM symbol includes a second valid symbol 105 and a GI 104.

In the example illustrated in FIG. 5, a delay time of a delay path exceeds the guard interval 101 of the main path. In the example illustrated in FIG. 5, in the delay path, an OFDM symbol associated with the Nth OFDM symbol of the main path includes a GI 107 and a first valid symbol 108. Before this OFDM symbol, a blank symbol 106 is adjacent. After this OFDM symbol, a blank symbol 109 is adjacent.

The reception device (the mobile station) executes reception processing by cutting out only a symbol of an FFT section 110 being a section excluding a signal having the same length as the GI 101 from the Nth OFDM symbol of the main path.

While in the example illustrated in FIG. 5, setting one OFDM symbol as a blank symbol, the transmission device may leave a plurality of OFDM symbols blank. For example, with regard to one OFDM symbol in which data are multiplexed, a plurality of OFDM symbols may be left blank.

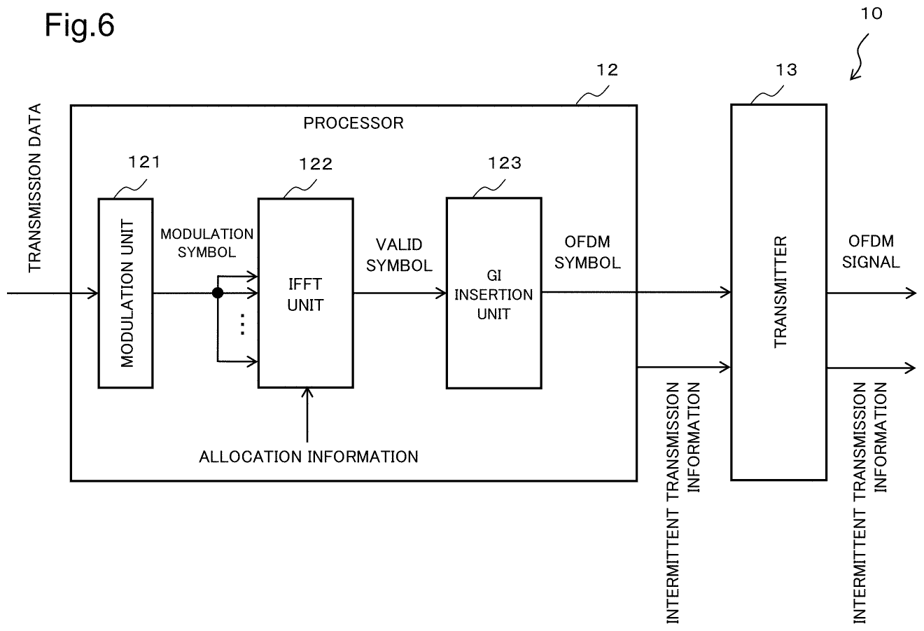

FIG. 6 illustrates a base station of the first example embodiment.

A base station 10 includes a processor 12 and a transmitter 13. The processor 12 includes a modulation unit 121, an IFFT unit 122, and a GI insertion unit 123.

The modulation unit 121 generates a modulation symbol from transmission data transmitted from the base statin 10 to a mobile station. Transmission data (information bits) to be transmitted to the mobile station input from a media access control (MAC) unit and the like (not illustrated and the MAC unit and the like are referred to as a function located in a higher layer such as a MAC layer and a network layer) are input to the modulation unit 121. An information bit is a signal in which an audio signal, a video signal, and another data signal subjected to compression coding is expressed by “0” and “1”. The information bit may be subjected to error correction coding processing such as turbo coding, low density parity check (LDPC), and convolution coding.

The modulation unit 121 generates, based on transmission data (information bits), a modulation symbol such as binary phase shift keying (BPSK), quadrature phase shift keying (QPSK), 16 quadrature amplitude modulation (16 QAM), and 64 quadrature amplitude modulation (64 QAM).

The IFFT unit 122 executes, based on allocation information notified of from a MAC unit and the like (not illustrated), mapping (subcarrier mapping) for a modulation symbol addressed to the mobile station input from the modulation unit 121 at an IFFT input point. At that time, a pilot symbol (a reference symbol) may be mapped. The IFFT unit 122 executes IFFT processing and thereby converts a modulation symbol from a frequency domain signal to a time domain signal (valid symbol). For simplification of description, description is made, assuming that the number of IFFT points and the number of subcarriers are the same, but is not intended be limited thereto. The number of subcarriers may be less than the number of IFFT points, or a plurality of IFFT units can be provided when the number of subcarriers is equal to or larger than the number of IFFT points.

A resource element (including one OFDM symbol and one subcarrier) for mapping a modulation symbol is notified of by allocation information. A resource element notified of by allocation information is determined based on a propagation path status between a base station and a mobile station and a data amount to be transmitted to the mobile station by the base station. Determination of a resource element for mapping the data modulation symbol is referred to as scheduling. Allocation information may be notified a mobile station of by using the same OFDM symbol as an OFDM symbol allocated with a modulation symbol or the same transmission frame as a transmission frame allocated with the modulation symbol, or may be notified of by using a different OFDM symbol or a different transmission frame. Allocation information may include a downlink physical resource block (PRB) allocation information (e.g., physical resource block position information such as a frequency and a time), a modulation system and a coding system (e.g., 16 QAM modulation and a ⅔ coding rate) associated with each downlink physical resource block (PRB), and the like.

Allocation information may be included in a control signal for a mobile station.

The GI insertion unit 123 adds a guard interval (GI) to a time domain signal converted by the IFFT unit 122. A part of a last half of a time domain signal (a valid symbol) output by the IFFT unit 122 is copied and added to a head of the valid symbol, for example. A valid symbol added with a GI is referred to as an OFDM symbol (see FIG. 5).

The transmitter 13 converts (executes digital to analog conversion for) an OFDM symbol output by the GI insertion unit 123 to an analog signal, executes filtering processing of restricting a bandwidth for the signal converted to the analog signal, up-converts the signal subjected to filtering processing to a transmittable frequency band, and transmits the up-converted signal via an antenna. The signal to be transmitted is referred to as an OFDM signal.

When the base station 10 performs intermittent transmission illustrated in FIG. 5 (the base station 10 is in an intermittent transmission mode), the processor 12 does not allocate transmission data to an OFDM symbol to be left blank.

The IFFT unit 122 does not map a modulation symbol, for example, in a valid symbol to be left blank. Further, the GI insertion unit 123 inserts a GI, based on a valid symbol allocated with no data. Therefore, an OFDM symbol output by the GI insertion unit 123 is a blank symbol.

The processor 12 generates information indicating that intermittent transmission is being performed (intermittent transmission information). The transmitter 13 notifies a mobile station of this intermittent transmission information. The mobile station demodulates only a necessary OFDM symbol, based on the notified information.

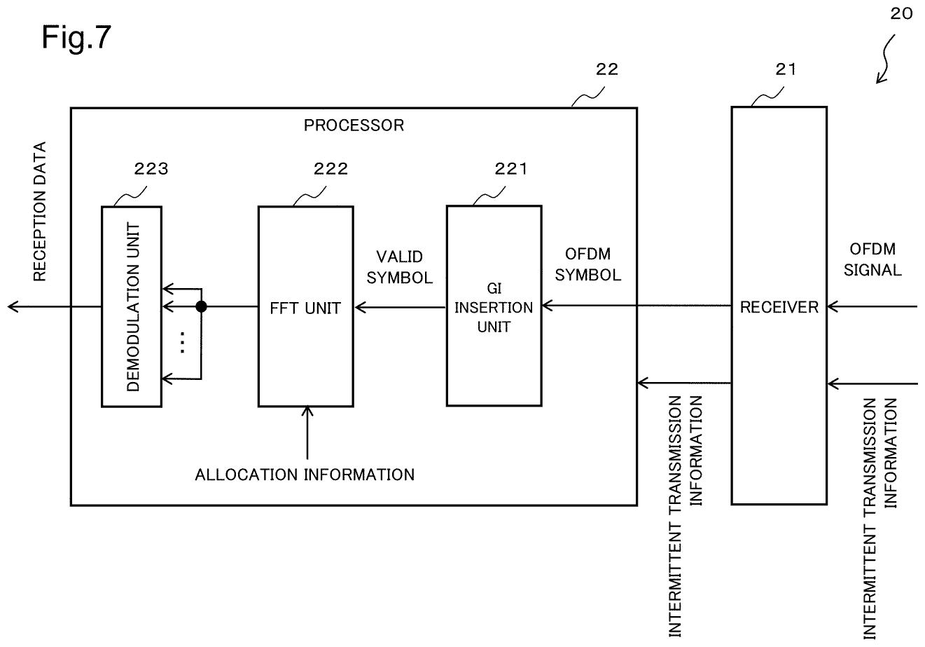

FIG. 7 illustrates a reception device (a mobile station) of the first example embodiment. The reception device (the mobile station) executes demodulation processing, based on an operation inverse to the operation of a transmission device.

A mobile station 20 include a receiver 21 and a processor 22. When a part or the whole of the receiver 21 and the processor 22 are formed into a chip and thereby an integrated circuit is formed, at least one processor that controls each function block may be provided.

The receiver 21 receives an OFDM signal transmitted from a transmission device (a base station) via an antenna (not illustrated), executes signal processing for the received OFDM signal, and transmits the processed OFDM signal to the processor 22. The receiver 21, for example, down-converts a received signal to a frequency band able to be subjected to digital signal processing such as signal detection processing, executes filtering processing for spurious elimination, and converts (executes analog to digital conversion for) the signal subjected to filtering processing from an analog signal to a digital signal. The signal subjected to these processings may be temporarily stored on a storage device such as a memory and a buffer before transmitted to the processor 22.

When an OFDM signal illustrated in FIG. 2 is received, a frequency response is calculated by using a signal (one or two or more signal components among resource elements) of a subcarrier allocated with a pilot symbol, the signal being a signal acquired by converting the received OFDM signal to a frequency domain. A frequency response of a subcarrier other than a subcarrier in which a pilot symbol is disposed can be calculated based on an interpolation technique such as linear interpolation and FFT interpolation, by using a frequency response of a subcarrier in which a pilot symbol is disposed.

A GI elimination unit 221 eliminates a guard interval section added by a transmission device in order to avoid distortion due to a delay wave.

An FFT unit 222 executes Fourier transform processing of converting a signal (a valid symbol) in which the GI elimination unit 221 eliminates a guard interval section from a time domain signal to a frequency domain signal in an FFT section.

The FFT unit 222 may execute demapping processing for a frequency domain signal. Specifically, only a signal of a subcarrier mapped to a desired user (the mobile station 20) is extracted from among frequency domain signals. The processor 22 can interpret, based on a notification using a control signal and the like, disposition (allocation information) of a modulation symbol or a pilot (reference) symbol of a desired user mapped in a subcarrier of a received OFDM signal.

A demodulation unit 223 extracts only a signal (a resource element in which a modulation symbol is mapped) of a subcarrier in which a desired user (the mobile station 20) is mapped from among signals output by the FFT unit 222, executes demodulation processing, and acquires reception data (information bits) of the mobile station 20. Each subcarrier is used for conveying a modulation symbol.

The receiver 21 may receive intermittent transmission information. Intermittent transmission information includes information indicating that intermittent transmission is being performed. Intermittent transmission information includes, for example, information announcing disposition of data of a symbol unit. The information indicates what symbol is a blank symbol. Further, intermittent transmission information may include information indicating how the processor 22 processes a blank symbol. The information, for example, interprets that data do not exist in a blank symbol and indicates that the processor 22 issues an instruction for executing demodulation processing. Further, the information indicates that the processor 22 issues an instruction for executing puncturing processing in a blank symbol. Intermittent transmission information may be transmitted as information of higher layer signaling through a physical downlink shared channel (PDSCH) or may be transmitted as a control signal through a physical downlink control channel (PDCCH) or a physical broadcast channel (PBCH). In this case, intermittent transmission information is output based on processing of the demodulation unit 223.

The processor 22 may execute, based on the intermittent transmission information, demodulation processing for only a necessary OFDM symbol. The processor 22 can determine that intermittent transmission is being performed in a downlink, based on reception power. In this case, intermittent transmission information is not always necessary in processing of the processor 22.

The present example embodiment is able to reduce, for example, in an LTE system, an inter-symbol interference also in an environment of a cell radius of equal to or larger than 10 km where a delay wave having a delay time exceeding a guard interval section occurs.

Further, the present example embodiment can be carried out by using an existing LTE frame format and modifying a method (a scheduling method) for resource allocation of an LTE base station. Therefore, a cost can be reduced, compared with when an interference reduction equalizer is introduced into a mobile station and a base station and when a new LTE communication standard is made and all devices are developed.

### Second Example Embodiment

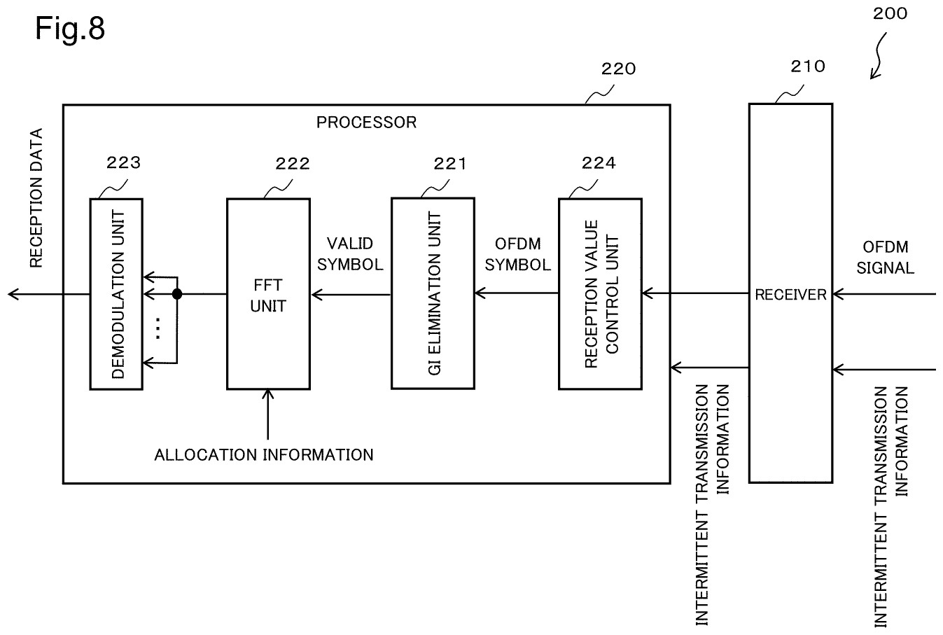

FIG. 8 illustrates a mobile station of a second example embodiment. A mobile station 200 of FIG. 8 illustrates one specific example of the mobile station 20 of the first example embodiment. The mobile station 200 includes a receiver 210 and a processor 220. The processor 220 includes a GI elimination unit 221, an FFT unit 222, a demodulation unit 223, and a reception value control unit 224. The GI elimination unit 221, the FFT unit 222, and the demodulation unit 223 are similar to the first example embodiment, and therefore for description simplification, details thereof are omitted.

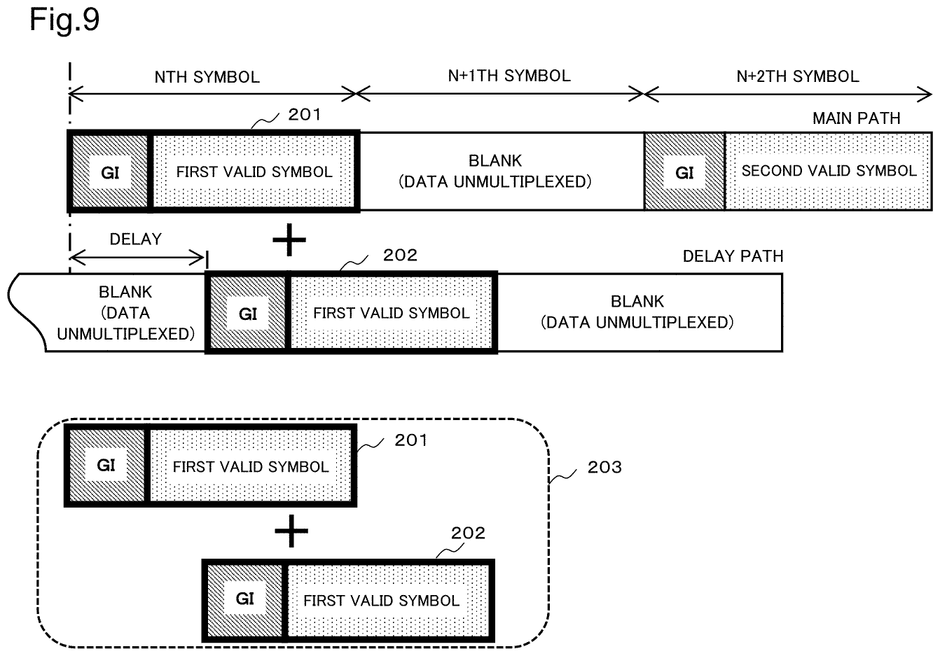

The reception value control unit 224 executes control illustrated in FIGS. 9 to 11 for an OFDM symbol received from the receiver 210 and transmits a generated OFDM symbol to the GI elimination unit 221.

FIG. 9 illustrates one example of a reception signal according to the second example embodiment. The reception signal of FIG. 9 is similar to the signal of FIG. 5.

In the following, for description simplification, details of only an OFDM symbol of a main path (a main OFDM symbol 201) and an OFDM symbol of a delay path (a delay OFDM symbol 202) are described.

The main OFDM symbol 201 includes a first valid symbol and a GI thereof. The delay OFDM symbol 202 includes a first valid symbol and a GI thereof.

A delay wave of a delay path and a direct wave of a main path are synthesized and arrive at the mobile station 200 as a synthesized wave 203. The synthesized wave 203 in the present example is acquired by synthesizing the main OFDM symbol 201 and the delay OFDM symbol 202.

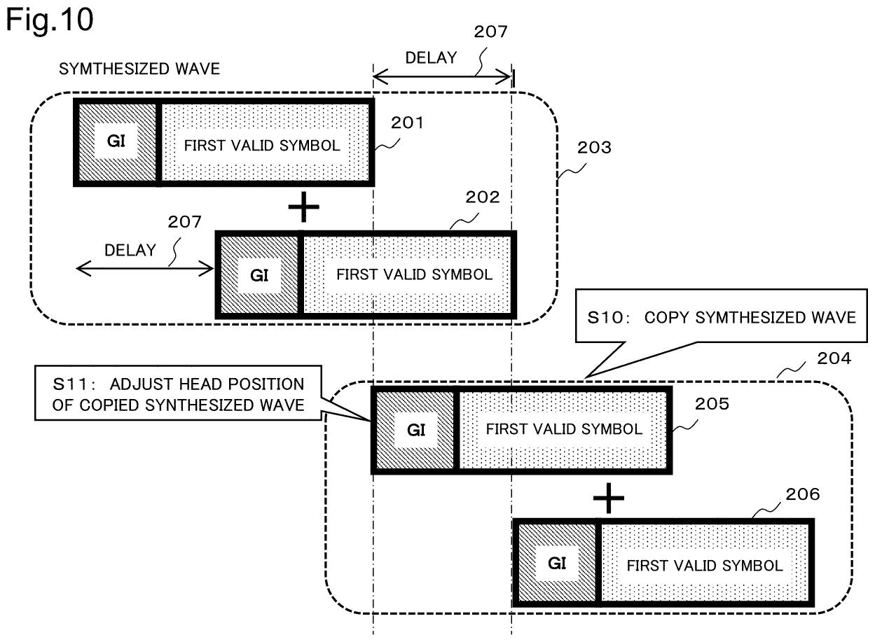

FIG. 10 illustrates an outline of an operation relating to the mobile station of the second example embodiment. The reception value control unit 224 copies a synthesized wave 203 and generates a copied synthesized wave 204 (S10).

Next, the reception value control unit 224 adjusts a position relation in a time direction between the synthesized wave 203 and the copied synthesized wave 204 in such a way as to be able to appropriately demodulate the copied synthesized wave 204. Specifically, a position relation is adjusted in such a way that a head of a copied main OFDM symbol 205 is located immediately after the main OFDM symbol 201 (S11, the synthesized wave 204 is disposed at a temporal position before a time corresponding to a delay time 207 from behind the synthesized wave 203).

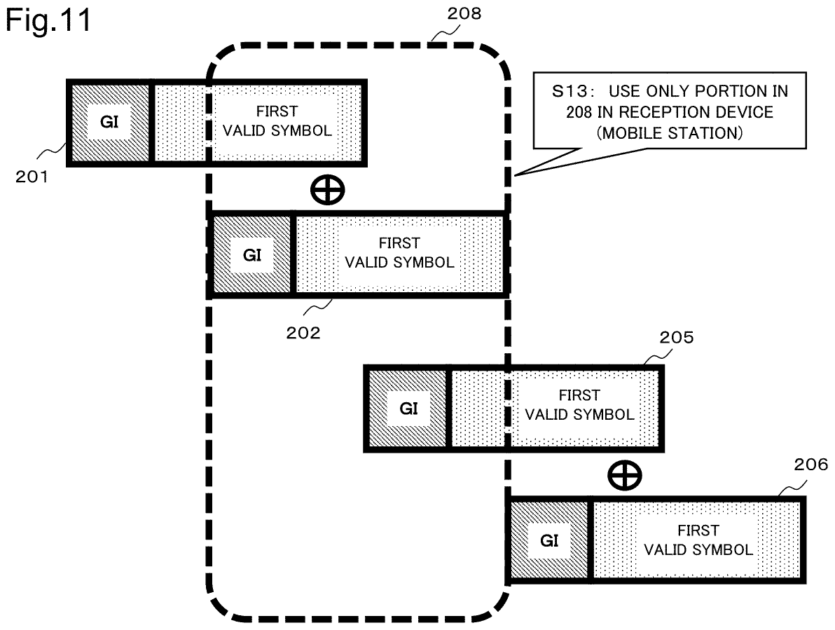

FIG. 11 illustrates an outline of an operation relating to the mobile station of the second example embodiment. FIG. 11 illustrates an operation following FIG. 10.

The processor 220 executes reception processing by using only a section 208 associated with a delay OFDM symbol (S13). Specifically, in the processor 220, the GI elimination unit 221 eliminates a GI with respect to an OFDM symbol of the section 208 associated with a delay OFDM symbol, the FFT unit 222 performs Fourier transform for a first valid symbol, and the demodulation unit 223 executes demodulation processing.

According to the present example embodiment, in a section 208 associated with a delay OFDM symbol, a first half portion of an OFDM symbol 205 is located in a portion associated with a blank symbol adjacent to a main OFDM symbol 201. Thereby, in a dotted line portion 208, a discontinuous section between OFDM symbols disappears and two symbols having high correlativity are processed, and therefore an interference can be further reduced, compared with the firs example embodiment. In other words, an influence of an interference caused by a delay path can be further reduced.

Further, the present example embodiment can be achieved based on simple processing of modifying signal processing of a mobile station without a load on signal processing of a base station side. An achievement can be made merely by controlling, for example, a value of a reception buffer of a mobile station, and therefore a modification for new hardware is not required.

### Third Example Embodiment

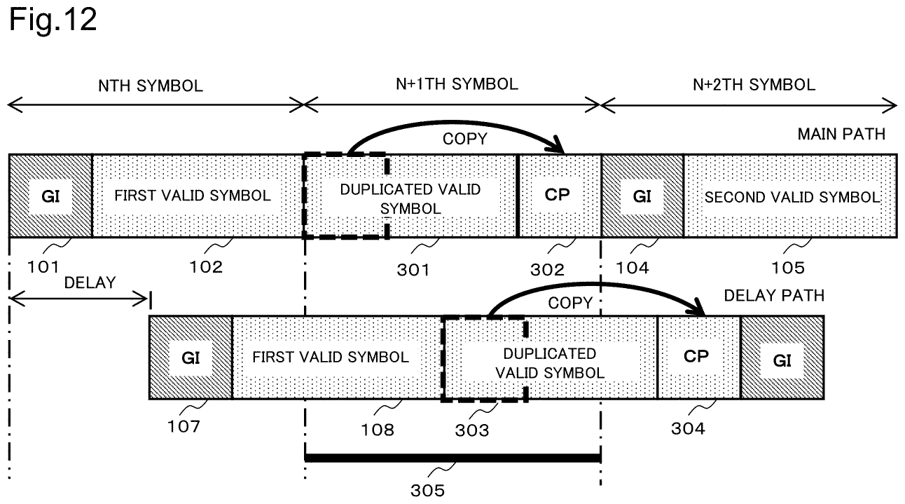

FIG. 12 illustrates one example of a transmission signal according to a third example embodiment.

Configurations of a base station and a mobile station in the present example embodiment are similar to the first example embodiment.

In the first and second example embodiments, an OFDM symbol adjacent to an OFDM symbol in which data are multiplexed was a blank symbol. In the third example embodiment, a posterior OFDM symbol is the same as an anterior OFDM symbol between adjacent OFDM symbols.

In the present example embodiment, leaving a posterior OFDM symbol blank between adjacent OFDM symbols includes not only setting the posterior OFDM symbol as a blank symbol but also configuring the posterior OFDM symbol in the same manner as an anterior OFDM symbol.

In the third example embodiment, a processor 12 of a base station 10 generates an Nth OFDM symbol and then generates an N+1th OFDM symbol. The Nth OFDM symbol includes a first valid symbol 102 and a guard interval 101. The N+1th OFDM symbol includes a duplicated valid symbol 301 being a duplicate of the first valid symbol 102 and a cyclic prefix 302 generated from the duplicated valid symbol 301.

Specifically, when allocation information supplied to an IFFT unit 122 indicates that the same data as data included in an Nth OFDM symbol are allocated to an N+1th OFDM symbol, the IFFT unit 122 may execute processing in the IFFT unit 122 by using an anterior modulation symbol. For example, at an input point of IFFT, the same modulation symbol as a modulation symbol of the Nth symbol is mapped. In this case, further, a CP 302 being a signal in which a first half portion of a duplicated valid symbol 301 is duplicated is added to an end of the duplicated valid symbol 301.

Alternatively, a GI insertion unit 123 inserts a GI 101 of an Nth symbol, and then the GI insertion unit 123 or the processor 12 may generate, from an Nth OFDM symbol, a first valid symbol 301 and a CP 302 and generate an N+1th OFDM symbol.

A reception device (a mobile station) executes demodulation processing, for example, by using a section 305 associated with an N+1th symbol of a main path. A section used in demodulation is not limited to the 305 section. For example, by using a symbol of an FFT section portion between a head of GI 107 of a delay path and an end of the section 305, reception (demodulation) processing may be executed.

Further, a mobile station may receive, from a base station, information indicating on what OFDM symbol the same data are multiplexed, instead of intermittent transmission information in the first example embodiment. In the case of the present example, the information indicates that a next N+1th symbol is a copy of an Nth symbol.

Further, in the third example embodiment, the processor 12 generates an N+2th OFDM symbol. The N+2th OFDM symbol includes a second valid symbol 105 different from a first valid symbol and a guard interval 104 thereof.

According to the present example embodiment, a signal in which continuity of an FFT cycle is maintained is transmitted to an anterior OFDM symbol as a next OFDM symbol, and thereby while an existing LTE frame format is used, a guard interval can be extended. Thereby, an interference caused by a delay can be reduced.

### Fourth Example Embodiment

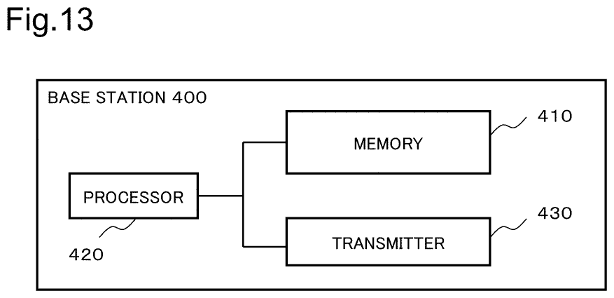

A fourth example embodiment describes one specific example of the example embodiments described above. FIG. 13 illustrates a base station according to the fourth example embodiment. A base station 400 of the present example embodiment includes a memory 410, a processor 420, and a transmitter 430. The processor 420 is similar to the processor 12 of the example embodiments described above. The transmitter 430 is similar to the transmitter 13 of the example embodiments described above.

The processor 420 may determine that an OFDM symbol is left blank, based on control information stored on the memory 410. The processor 420 may determine that at least one of a plurality of subcarriers configuring a first valid symbol is left blank, based on control information stored on the memory 410.

Further, the processor 420 may determine that a blank is set when a delay time of a delay path relative to a main path where a first OFDM signal has been transmitted in a multipath environment exceeds a first guard interval.

The processor 420 may determine an OFDM symbol used for transmission depending on a cell radius. The processor 420 determines that when, for example, a cell radius is small (e.g., less than 10 km), communication is performed in a normal transmission mode that performs transmission by using all OFDM symbols. Further, the processor 420 determines that when, for example, a cell radius is large (e.g., equal to or more than 10 km), communication is performed in an intermittent transmission mode that performs transmission for every one OFDM symbol.

Further, the processor 420 may determine an OFDM symbol used for transmission, based on the number of mobile stations existing in a cell of the base station 400 (an intermittent transmission mode or a normal transmission mode may be determined).

Further, the processor 420 may determine an intermittent transmission mode or a normal transmission mode, based on a position of a mobile station. When, for example, a ratio of mobile stations in which a distance from the base station 400 exceeds x km is equal to or larger than y%, the processor 420 may determine that communication is performed in an intermittent transmission mode in which data are multiplexed for every one OFDM symbol.

Further, the processor 420 may determine an intermittent transmission mode or a normal transmission mode, based on a delay spread being one indicator for determining a delay.

The processor 420 may measure a delay spread, for example, for each mobile station communicable with the base station 400. When a ratio of mobile stations in which the measured delay spread exceeds s seconds is equal to or larger than z%, the processor 420 may determine that communication is performed in an intermittent transmission mode in which data are multiplexed for every one OFDM symbol.

Further, the processor 420 may identify an area having a large delay, based on data of an examination on radio wave propagation previously conducted and determine, in the case of the area, that communication is performed in an intermittent transmission mode in which data are multiplexed for every one OFDM symbol.

The transmitter 430 may concentrate, in the case of an intermittent transmission mode, power on an OFDM symbol to be used.

The memory 410 stores control information. Control information may be, for example, information previously set or information acquired by the processor 420 and the like. The processor 420 determine whether a blank is set, based on control information. The processor 420 can acquire control information from the memory 410, for example, in order to determine whether a blank is set (e.g., determination of an OFDM symbol). The processor 420 determines an OFDM symbol to be left blank, based on the acquired control information.

Control information may include, for example, information relating to a radius of a cell of the base station 400. Information relating to a cell radius, for example, may be previously set by an operator and the like or may be acquired from a management device such as a self organizing network (SON) server. An SON server determines a radius of a cell and then transmits the determined information to the base station 400 by considering a relation between the base station 400 and an already existing base station when the base station 400 is newly installed. The transmitted information relating to the cell radius is stored on the memory 410.

Control information may include, for example, the number of mobile stations existing in a cell of the base station 400. The number of mobile stations is updated at a predetermined cycle, and when the number of mobiles stations exceeds a predetermined value, the processor 420 may determine that an intermittent transmission mode moves to a normal transmission mode. Further, the number of mobile stations is equal to or smaller than the predetermined value, the processor 420 may determine that an intermittent transmission mode is performed.

Control information may include, as information indicating a position of a mobile station, global positioning system (GPS) information of each mobile station. The GPS information may be acquired from a position information management server that is not illustrated. Position information of a mobile station may be information capable of estimating a distance between a base station and a mobile station determined from a delay difference of an uplink signal. Position information of a mobile station may be information capable of estimating a distance between a base station and a mobile station such as propagation quality (e.g., a signal to interference plus noise ratio (SINR) or a channel quality indicator (CQI)) of a downlink measured in a mobile station. In this case, when an SINR or a CQI is lower than a previously determined value, it is determined that a distance between a base station and a mobile station is far. Alternatively, a result acquired by determining, based on propagation quality or reception quality of an uplink signal, whether a mobile station of a transmission source of the uplink signal is located at an edge of a cell may be stored on the memory 410 as information indicating a position of the mobile station.

Control information may include a delay spread acquired in the processor 420. A delay spread is an amount indicating spreading of a delay time of each radio wave arriving at a base station. In general, in an area where there are a large number of obstacles in a mobile station periphery and visibility of a circumference is poor, a reflective wave from a long distance and the like are blocked by the obstacles and is difficult to arrive at the mobile station, and therefore a delay spread is small. On the other hand, in an area where there are a small number of obstacles in a mobile station periphery and visibility of a circumference is excellent, a relatively large delay spread results.

The memory 410 previously examines whether a delay is large in a coverage covered by a base station after grounded and can store a result thereof as control information. In a case of an area where a delay is large, the processor 420 determines that an intermittent transmission mode is performed.

The present example embodiment is able to flexibly determine which one of an intermittent transmission mode or a normal transmission mode a base station performs according to a geographical/temporal situation where a base station is disposed. Therefore, the present example embodiment provides a mechanism for more flexibly reducing an interference.

### Fifth Example Embodiment

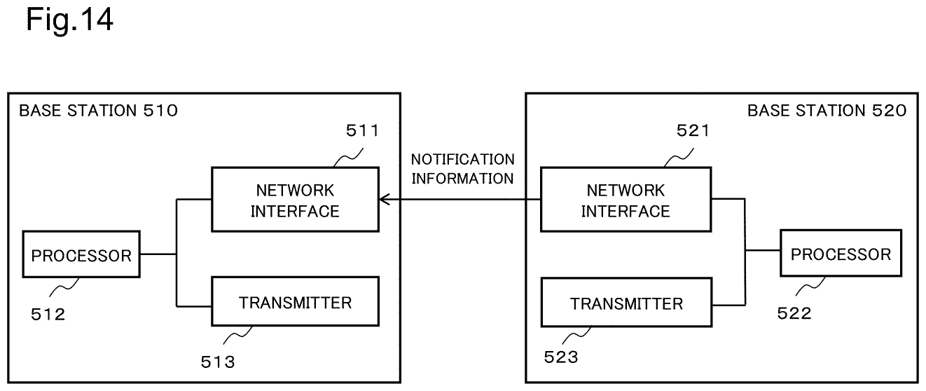

A fifth example embodiment describes one specific example of the example embodiments described above. FIG. 14 illustrates a plurality of base stations according to the fifth example embodiment. A communication system of the present example embodiment includes at least a base station 510 and a base station 520. The base station 510 includes a network interface 511, a processor 512, and a transmitter 513.

The base station 520 includes a network interface 521, a processor 522, and a transmitter 523.

The network interface 521 transmits notification information to the network interface 511. Notification information includes, for example, information indicating that the base station 520 is in an intermittent transmission mode. Notification information may include, for example, information indicating that another OFDM symbol adjacent to an OFDM symbol configuring an OFDM signal transmitted by the base station 520 is being left blank.

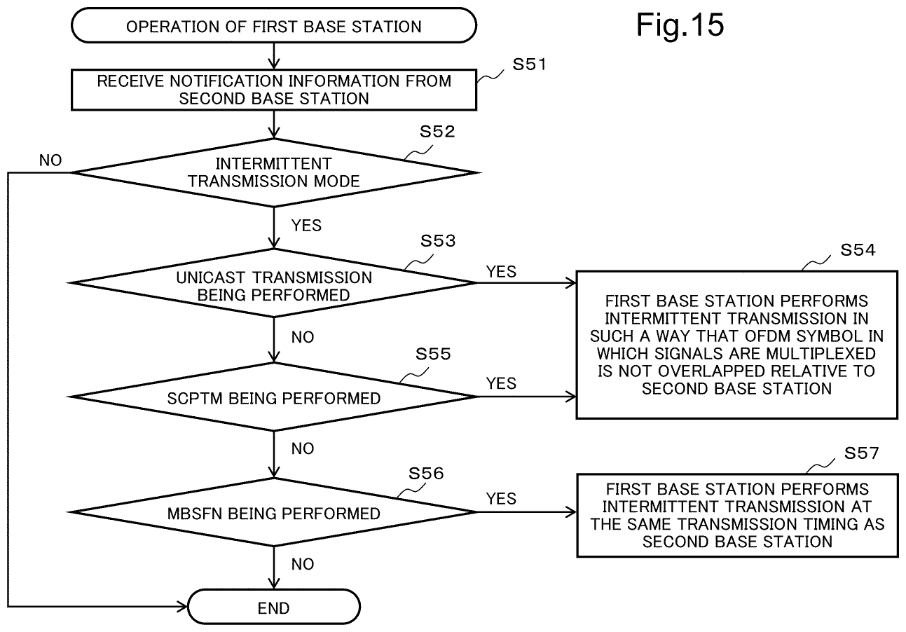

FIG. 15 illustrates an operation flowchart according to the fifth example embodiment.

In S51, the network interface 511 of the base station 510 receives notification information from the base station 520.

In S52, the processor 512 of the base station 510 determines whether the base station 510 is in an intermittent transmission mode. In the case of YES in S52, in other words, when the base station 510 is in an intermittent transmission mode, the base station 510 executes processing of S53.

In S53, when the notification information indicates that the base station 520 is performing unicast transmission (YES in S53), the processor 512 executes processing of S54.

In S54, the base station 510 performs intermittent transmission in such a way that an OFDM symbol in which signals are multiplexed is not overlapped relative to an adjacent base station (the base station 520) that performs intermittent transmission.

In the case of NO in S53, processing of S55 is executed.

When in S55, the base station 520 is performing single cell point to multi point (SC-PTM) (YES in S55), processing of S54 is executed. SC-PTM indicates that simultaneous reporting is performed to a plurality of terminals in one cell.

In the case of NO in S55, processing of S56 is executed.

When in S56, the base station 520 is performing MBMS single frequency network (MBSFN) (YES in S56), processing of S57 is executed. MBSFN indicates that a plurality of evolved node Bs (eNBs) perform simultaneous synchronization transmission for the same signal.

In S57, the base station 510 performs intermittent transmission at the same transmission timing as the adjacent base station (the base station 520) that performs intermittent transmission.

In the case of NO in S56 and in the case of NO in S52, an operation flow of FIG. 15 is terminated.

In the operations of S53 and S54, control is executed in such a way that an OFDM symbol in which signals are multiplexed is not overlapped relative to an adjacent base station that performs intermittent transmission. Thereby, occurrence of an inter-base station interference between the base station 510 and the base station 520 during unicast transmission can be avoided.

Further, in the operations of S55 and S54, similarly, for example, a transmission timing is shifted by one OFDM symbol with respect to an adjacent base station that performs intermittent transmission, and thereby control is executed in such as a way that an OFDM symbol in which signals are multiplexed is not overlapped relative to the adjacent base station that performs intermittent transmission. Thereby, occurrence of an inter-base station interference between the base station 510 and the base station 520 during SC-PTM can be avoided.

Further, transmission timings of the base station 510 and the base station 520 are matched with each other, based on the operations of S56 and S57 during MBSFN, and thereby a diversity gain can be achieved.

Note that the notification information described above may include, for example, information indicating an intermittent transmission mode state, information indicating a unicast, SC-PTM, or MBSFN state, information indicating that synchronization is required or synchronization is not required, and information relating to a timing of multiplexing data (an absolute time or a relative time). Information indicating that synchronization is required may include, for example, information indicating a shift amount (N symbols, N being an integer of equal to or larger than 0) for shifting a transmission timing and what symbol needs to be used for transmission.

Note that notification information may be transmitted via an X2 interface between the base station 510 and the base station 520.

### Sixth Example Embodiment

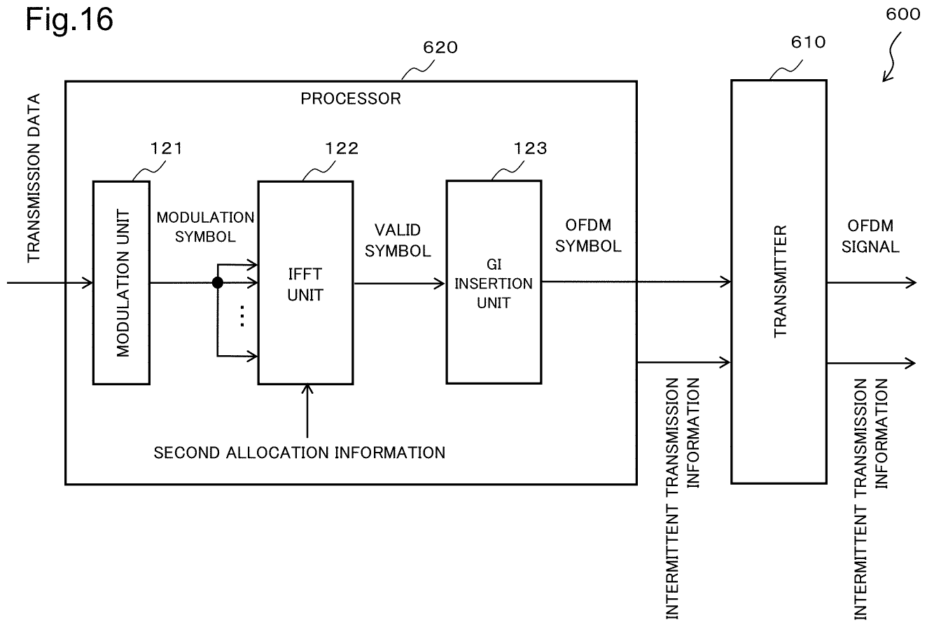

FIG. 16 illustrates a base station according to a sixth example embodiment. In FIG. 16, a base station 600 includes a transmitter 610 and a processor 620. The transmitter 610 and the processor 620 are similar to the transmitter and processor in the base station 10 of the first example embodiment. However, for example, different allocation information (second allocation information) is supplied to an IFFT unit 122.

The IFFT unit 122 executes mapping (subcarrier mapping) for a modulation symbol addressed to a mobile station input from a modulation unit 121 at an IFFT input point, based on second allocation information.

According to the present example embodiment, the second allocation information indicates that a modulation symbol is not subjected to mapping (is not mapped) in a resource block including at least one subcarrier or a plurality of subcarriers having a frequency lower than a predetermined value (referred to also as scheduling information).

Similarly to the other example embodiments, blanking in an OFDM symbol unit may be executed. In this case, the processor 620 generates intermittent transmission information, and the transmitter 610 transmits the information.

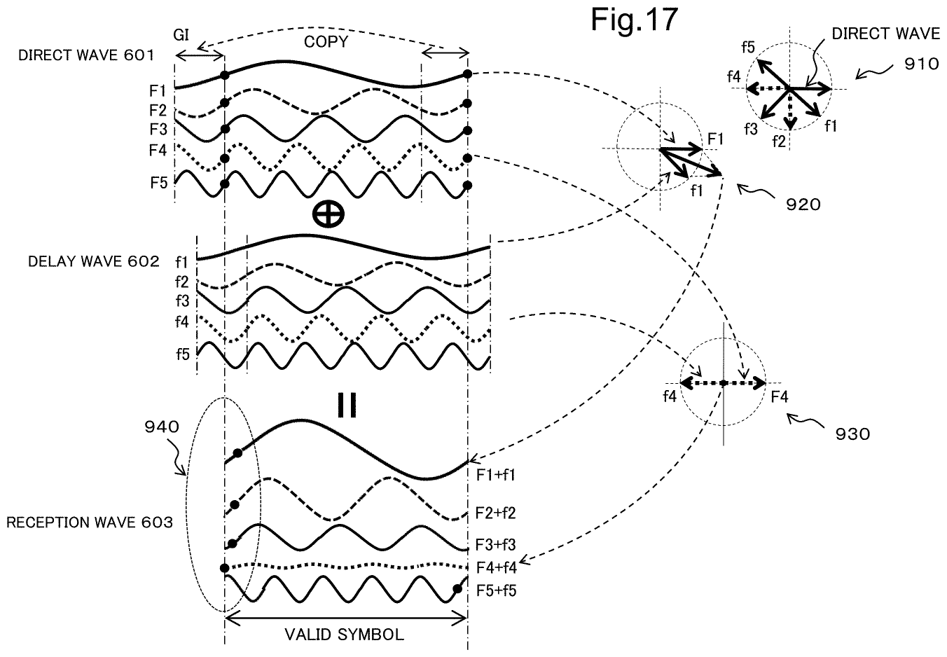

FIG. 17 illustrates a synthesized wave arriving at a mobile station according to the sixth example embodiment.

A direct wave 601 includes a valid symbol and a guard interval section, disposed before the valid symbol, that is added by copying a last half portion of the valid symbol. A delay wave 602 is a delay wave of the direct wave 601. A reception wave 603 is a synthesized wave in which the direct wave 601 and the delay wave 602 are synthesized and is a reception wave arriving at a mobile station.

In the direct wave 601, signs F1, F2, F3, F4, and F5 each exemplify subcarriers. A frequency of F1 is low and a frequency of F5 is high.

In the delay wave 602, signs F1, f2, f3, f4, and f5 each exemplify subcarriers. A frequency of f1 is low and a frequency of f5 is high.

In the reception wave 603, for example, F1+f1 represents a subcarrier in which F1 and f1 are synthesized (the same also applies to F2+f2, F3+f3, F4+f4, and F5+f5).

A sign 910 represents a rotation phasor of the delay wave 602 relative to the direct wave 601. The rotation phasor indicates phases of each subcarrier of the delay wave 602 including f1 to f5.

A rotation phasor in which, for example, the subcarrier F1 of the direct wave 601 and the subcarrier f1 of the delay wave 602 are synthesized is illustrated in a sign 920. In this example, a subcarrier of F1+f1 is delayed in phase relative to F1 and an amplitude of the subcarrier is large.

Further, a rotation phasor in which the subcarrier F4 of the direct wave 601 and the subcarrier f4 of the delay wave 602 are synthesized is illustrated in a sign 930. In this example, a subcarrier of F4+f4 is in an antiphase, relative to F4 and an amplitude of the subcarrier is small. Also with regard to other F2+f2, F3+f3, and F5+f5, a phase and an amplitude are determined by using a similar method. In a direct wave and a reception wave after synthesis, phases and amplitudes of each subcarrier are changed but there is no change in frequency.

In a border vicinity (640) of an anterior OFDM symbol, an interference is caused by an influence such as entrance of a discontinuous section. Therefore, a subcarrier in which, for example, a harmonic component is added to a sign 940 vicinity and then it is difficult for a waveform to form a distorted sine wave may be generated. When, for example, in a valid symbol (FFT section), it is difficult to form a sine wave for one cycle, it is difficult to demodulate a subcarrier thereof (it is difficult to extract a valid symbol length).

For example, in a subcarrier of F1+f1, it is difficult for a waveform of the sign 940 area to form a sine wave for one cycle of distortion.

In the present example embodiment, control is executed in such a way that a subcarrier affected by such an interference is left blank. In the case of the present example, second allocation information (scheduling information) indicating that a modulation symbol is not mapped in a subcarrier of F1+f1 is considered in the IFFT unit 122 of the processor 620 and processing in the IFFT unit 122 is executed.

According to the present example embodiment, when a subcarrier of a low subcarrier frequency is subjected to blanking and only a subcarrier of a high subcarrier frequency is used, an influence of an interference can be reduced. For example, in LTE intended for public safety (PS), the number of mobile stations in a cell may be smaller than in public wireless communication and there is a margin in wireless resources. In this case, blanking may be executed, for example, in a resource block unit (a 12-subcarrier unit).

A low frequency is a frequency (a subcarrier) in which a sine wave of one cycle able to be demodulated is drawn in a valid symbol length.

Control may be executed in such a way that, for example, a subcarrier in which a length for one cycle of the subcarrier is larger than a half of a valid symbol is subjected to blanking. The blanking may be achieved, for example, by not mapping transmission data in a subcarrier in which it has been difficult to configure a sine wave of one cycle.

### Seventh Example Embodiment

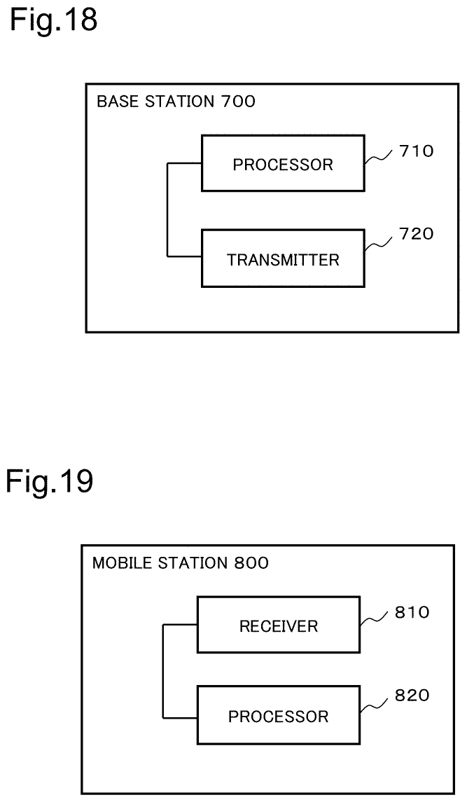

FIG. 18 illustrates a base station according to a seventh example embodiment. In FIG. 18, a base station 700 includes a processor 710 and a transmitter 720.

The processor 710 generates a first modulation symbol from transmission data. The processor 710 performs inverse Fourier transform for the first modulation symbol and thereby converts the first modulation symbol from a frequency domain signal to a first valid symbol being a time domain signal. The processor 710 inserts a first guard interval into the first valid symbol. The processor 710 outputs the inserted signal as a first orthogonal frequency division multiplexing (OFDM) symbol. The processor 710 is configured in such a way as to execute these operations.

Further, the transmitter 720 is configured in such a way as to transmit a first OFDM signal generated based on a first OFDM symbol.

The processor 710 leaves at least one of the following (a) or (b) blank.

(a) A second OFDM symbol adjacent to a first OFDM symbol
(b) At least one of a plurality of subcarriers configuring a first valid symbol

FIG. 19 illustrates a mobile station according to the seventh example embodiment. In FIG. 19, a mobile station 800 includes a receiver 810 and a processor 820.

The receiver 810 is configured in such a way as to receive a first orthogonal frequency division multiplexing (OFDM) signal generated based on a first OFDM symbol.

The processor 820 eliminates a first guard interval from a first OFDM symbol and thereby generates a first valid symbol. The processor 820 performs Fourier transform for the first valid symbol and thereby converts the first valid symbol being a time domain signal to a frequency domain signal. The processor 820 executes demodulation processing, based on the frequency domain signal and generates transmission data. The processor 820 is configured in such a way as to execute these operations.

At least one of the following (a) or (b) is blank.

(a) A second OFDM symbol adjacent to a first OFDM symbol
(b) At least one of a plurality of subcarriers configuring a first valid symbol

The present example embodiment is able to provide a new mechanism capable of reducing an interference caused by a delay of a multipath.

### Another Example Embodiment

In the example embodiments described above, downlink communication in which a transmission device is a base station and a reception device is a mobile station is described. The example embodiments are not limited thereto and are applicable, for example, to uplink communication.

In uplink communication, a wireless access system referred to as single carrier frequency division multiple access (SC-FDMA) is used. In SC-FDMA, similarly to downlink orthogonal frequency division multiple access (OFDMA), OFDM is used as a modulation system and one RB of a subcarrier is 180 kHz. A similar mechanism is employed in this manner and therefore the example embodiments described above are applicable to uplink communication.

In the above description, processing executed by components of a base station and a mobile station may be executed by logic circuits, each produced according to a purpose.

Further, it may be possible that a computer program (hereinafter, referred to as a program) in which processing contents are described as a procedure is recorded on a recording medium readable by each of elements configuring a communication system and the program recorded on the recording medium is read and executed by each of components of a wireless communication system.

The program recorded on the recording medium is read by a central processing unit (CPU) included in each of components of a communication system and processing similar to the processing described above is executed based on control of the CPU. The CPU operates as a computer that executes a program read from a recording medium recording the program.

In the example described above, a program is stored by using various types of non-transitory computer-readable medium and can be supplied to a computer. The non-transitory computer-readable medium includes various types of tangible storage medium. Examples of the non-transitory computer-readable medium include a magnetic recording medium (e.g., a flexible disk, a magnetic tape, and a hard disk drive), a magnetooptical recording medium (e.g., a magnetooptical disc), a compact disc-read only memory (CD-ROM), a CD-R, a CD-R/W, a digital versatile disk (DVD), a semiconductor memory (e.g., a mask ROM, a programmable ROM (PROM), an erasable PROM (EPROM), a flash ROM, and a random access memory (RAM). Further, the program may be supplied to a computer by using various types of transitory computer-readable medium. Examples of the transitory computer-readable medium include an electric signal, an optical signal, and an electromagnetic wave. The transitory computer-readable medium can supply a program to a computer via a wired communication path such as an electric wire and an optical fiber or a wireless communications path.

It should be understood that the present invention is not limited to only the example embodiments described above and can be subjected to various modifications without departing from the spirit of the present invention already described. The functions or the steps and/or the operations based on the example embodiments described in the present description may not necessarily executed in a specific order. Further, an element of the present invention may be described or claimed in a singular form but may be plural as long as it is not described explicitly that the element is limited to a singular form.

<Supplementary Note>

The whole or part of the example embodiments described above can be described as the following supplementary notes. However, the following supplementary notes are merely illustrative of the present invention and the present invention is not limited to only such cases.

### (Supplementary Note 1)

A base station comprising:

a processor that

generates a first modulation symbol from transmission data,

converts the first modulation symbol from a frequency domain signal to a first valid symbol being a time domain signal by performing inverse Fourier transform for the first modulation symbol,

inserts a first guard interval into the first valid symbol, and

outputs an inserted signal as a first orthogonal frequency division multiplexing (OFDM) symbol; and

a transmitter that transmits a first OFDM signal generated based on the first OFDM symbol, wherein

the processor

leaves blank at least one of

a second OFDM symbol adjacent to the first OFDM symbol or at least one of a plurality of subcarriers configuring the first valid symbol.

### (Supplementary Note 2)

The base station according to supplementary note 1, wherein

leaving the second OFDM symbol blank includes

not mapping transmission data into at least one of a plurality of subcarriers configuring the second OFDM symbol.

### (Supplementary Note 3)

The base station according to supplementary note 1, wherein

leaving the second OFDM symbol blank includes

configuring the second OFDM symbol in a same manner as the first OFDM symbol.

### (Supplementary Note 4)

The base station according to supplementary note 3, further comprising a memory that stores control information, wherein

the processor

determines whether the blank is set, based on the control information.

### (Supplementary Note 5)

The base station according to supplementary note 4, wherein,

when the control information

indicates that a delay time of a delay path relative to a main path where the first OFDM signal is transmitted in a multipath environment exceeds the first guard interval,

the processor

determines that the blank is set.

### (Supplementary Note 6)

The base station according to any one of supplementary notes 1 to 5, further comprising an interface that receives notification information from a second base station, wherein

the notification information

indicates that a fourth OFDM symbol adjacent to a third OFDM symbol configuring a third OFDM signal transmitted by the second base station is being left blank.

### (Supplementary Note 7)

The base station according to any one of supplementary notes 1 to 6, wherein

leaving blank at least one of a plurality of subcarriers configuring the first valid symbol includes

not mapping transmission data into a subcarrier where it becomes difficult to configure a sine wave of one cycle.

### (Supplementary Note 8)

A mobile station comprising: a receiver that receives a first orthogonal frequency division multiplexing (OFDM) signal generated based on a first OFDM symbol; and

a processor that

generates a first valid symbol by eliminating a first guard interval from the first OFDM symbol,

converts the first valid symbol being a time domain signal to a frequency domain signal by performing Fourier transform for the first valid symbol, and

generates transmission data by executing demodulation processing, based on the frequency domain signal, wherein

at least one of a second OFDM symbol adjacent to the first OFDM symbol or at least one of a plurality of subcarriers configuring the first valid symbol is blank.

### (Supplementary Note 9)

The mobile station according to supplementary note 8, wherein,

when the second OFDM symbol is blank,

transmission data are not mapped into at least one of a plurality of subcarriers configuring the second OFDM symbol.

### (Supplementary Note 10)

The mobile station according to supplementary note 8, wherein,

when the second OFDM symbol is blank,

the second OFDM symbol is configured in a same manner as the first OFDM symbol.

### (Supplementary Note 11)

The mobile station according to supplementary note 8, wherein,

when a delay time of a delay path relative to a main path where the first OFDM signal is transmitted in a multipath environment exceeds the first guard interval,

the second OFDM symbol adjacent to the first OFDM symbol is blank.

### (Supplementary Note 12)

A control method for a base station, the method comprising:

generating a first modulation symbol from transmission data;

converting the first modulation symbol from a frequency domain signal to a first valid symbol being a time domain signal by performing inverse Fourier transform for the first modulation symbol;

inserting a first guard interval into the first valid symbol;

outputting an inserted signal as a first orthogonal frequency division multiplexing (OFDM) symbol;

transmitting a first OFDM signal generated based on the first OFDM symbol; and

leaving blank at least one of

a second OFDM symbol adjacent to the first OFDM symbol or at least one of a plurality of subcarriers configuring the first valid symbol.

### (Supplementary Note 13)

The control method for the base station according to supplementary note 12, wherein

leaving the second OFDM symbol blank includes

not mapping transmission data into at least one of a plurality of subcarriers configuring the second OFDM symbol.

### (Supplementary Note 14)

The control method for the base station according to supplementary note 12, wherein

leaving the second OFDM symbol blank includes

configuring the second OFDM symbol in a same manner as the first OFDM symbol.

### (Supplementary Note 15)

The control method for the base station according to supplementary note 14, the method further comprising:

storing control information; and

determining whether the blank is set, based on the control information.

### (Supplementary Note 16)

The control method for the base station according to supplementary note 15, the method further comprising

determining that the blank is set

when the control information

indicates that a delay time of a delay path relative to a main path where the first OFDM signal is transmitted in a multipath environment exceeds the first guard interval.

### (Supplementary Note 17)

The control method for the base station according to any one of supplementary notes 12 to 16, the method further comprising

receiving notification information from a second base station, wherein

the notification information

indicates that a fourth OFDM symbol adjacent to a third OFDM symbol configuring a third OFDM signal transmitted by the second base station is being left blank.

### (Supplementary Note 18)

The control method for the base station according to any one of supplementary notes 12 to 17, wherein

leaving blank at least one of a plurality of subcarriers configuring the first valid symbol includes

not mapping transmission data into a subcarrier where it becomes difficult to configure a sine wave of one cycle.

### (Supplementary Note 19)

A control method for a mobile station, the method comprising: receiving a first orthogonal frequency division multiplexing (OFDM) signal generated based on a first OFDM symbol;

generating a first valid symbol by eliminating a first guard interval from the first OFDM symbol;

converting the first valid symbol being a time domain signal to a frequency domain signal by performing Fourier transform for the first valid symbol; and

generating transmission data by executing demodulation processing, based on the frequency domain signal, wherein

at least one of a second OFDM symbol adjacent to the first OFDM symbol or at least one of a plurality of subcarriers configuring the first valid symbol is blank.

### (Supplementary Note 20)

The control method for the mobile station according to supplementary note 19, wherein,

when the second OFDM symbol is blank,

transmission data are not mapped into at least one of a plurality of subcarriers configuring the second OFDM symbol.

### (Supplementary Note 21)

The control method for the mobile station according to supplementary note 19, wherein,

when the second OFDM symbol is blank,

the second OFDM symbol is configured in a same manner as the first OFDM symbol.

### (Supplementary Note 22)

The control method for the mobile station according to supplementary note 19, wherein,

when a delay time of a delay path relative to a main path where the first OFDM signal is transmitted in a multipath environment exceeds the first guard interval,

the second OFDM symbol adjacent to the first OFDM symbol is blank.

### (Supplementary Note 23)

A non-transitory computer-readable recording medium recording a program that causes a computer to execute:

generating a first modulation symbol from transmission data;

converting the first modulation symbol from a frequency domain signal to a first valid symbol being a time domain signal by performing inverse Fourier transform for the first modulation symbol;

inserting a first guard interval into the first valid symbol;

outputting an inserted signal as a first orthogonal frequency division multiplexing (OFDM) symbol;

transmitting a first OFDM signal generated based on the first OFDM symbol; and

leaving blank at least one of

a second OFDM symbol adjacent to the first OFDM symbol or at least one of a plurality of subcarriers configuring the first valid symbol.

### (Supplementary Note 24)

The non-transitory computer-readable recording medium recording the program according to supplementary note 23, wherein

leaving the second OFDM symbol blank includes

not mapping transmission data into at least one of a plurality of subcarriers configuring the second OFDM symbol.

### (Supplementary Note 25)

The non-transitory computer-readable recording medium recording the program according to supplementary note 23, wherein

leaving the second OFDM symbol blank includes

configuring the second OFDM symbol in a same manner as the first OFDM symbol.

### (Supplementary Note 26)

The non-transitory computer-readable recording medium recording the program according to supplementary note 25, wherein

the program stores control information; and

determines whether the blank is set, based on the control information.

### (Supplementary Note 27)

The non-transitory computer-readable recording medium recording the program according to supplementary note 26, wherein

the program determines that the blank is set

when the control information

indicates that a delay time of a delay path relative to a main path where the first OFDM signal is transmitted in a multipath environment exceeds the first guard interval.

### (Supplementary Note 28)

The non-transitory computer-readable recording medium recording the program according to any one of supplementary notes 23 to 27, wherein

the program receives notification information from a second base station, and the notification information

indicates that a fourth OFDM symbol adjacent to a third OFDM symbol configuring a third OFDM signal transmitted by the second base station is being left blank.

### (Supplementary Note 29)

The non-transitory computer-readable recording medium recording the program according to any one of supplementary notes 23 to 28, wherein

leaving blank at least one of a plurality of subcarriers configuring the first valid symbol includes

not mapping transmission data into a subcarrier where it becomes difficult to configure a sine wave of one cycle.

### (Supplementary Note 30)

A communication system comprising:

a base station; and

a mobile station, wherein

the base station

generates a first modulation symbol from transmission data,

converts the first modulation symbol from a frequency domain signal to a first valid symbol being a time domain signal by performing inverse Fourier transform for the first modulation symbol,

inserts a first guard interval into the first valid symbol,

outputs an inserted signal as a first orthogonal frequency division multiplexing (OFDM) symbol,

transmits a first OFDM signal generated based on the first OFDM symbol, and

leaves blank at least one of

a second OFDM symbol adjacent to the first OFDM symbol or at least one of a plurality of subcarriers configuring the first valid symbol, and

the mobile station

receives the first OFDM signal,

generates the first valid symbol by eliminating the first guard interval from the first OFDM symbol included in the first OFDM signal,

converts the first valid symbol being a time domain signal to a frequency domain signal by performing Fourier transform for the first valid symbol, and

generates transmission data by executing demodulation processing, based on the frequency domain signal.

### (Supplementary Note 31)

The communication system according to supplementary note 30, wherein

leaving the second OFDM symbol blank includes

not mapping transmission data into at least one of a plurality of subcarriers configuring the second OFDM symbol.

### (Supplementary Note 32)

The communication system according to supplementary note 30, wherein

leaving the second OFDM symbol blank includes

configuring the second OFDM symbol in a same manner as the first OFDM symbol.

### (Supplementary Note 33)

The communication system according to supplementary note 32, wherein

the base station

stores control information and

determines whether the blank is set, based on the control information.

### (Supplementary Note 34)

The communication system according to supplementary note 33, wherein,

when the control information

indicates that a delay time of a delay path relative to a main path where the first OFDM signal is transmitted in a multipath environment exceeds the first guard interval,

the base station determines that the blank is set.

### (Supplementary Note 35)

The communication system according to any one of supplementary notes 30 to 34, wherein

notification information is transmitted from a second base station to the base station, and

the notification information

indicates that a fourth OFDM symbol adjacent to a third OFDM symbol configuring a third OFDM signal transmitted by the second base station is being left blank.

### (Supplementary Note 36)

The communication system according to any one of supplementary notes 30 to 35, wherein

leaving blank at least one of a plurality of subcarriers configuring first valid symbol includes

not mapping transmission data into a subcarrier where it becomes difficult to configure a sine wave of one cycle.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-007205, filed on Jan. 19, 2017, the disclosure of which is incorporated herein in its entirety by reference.

### REFERENCE SIGNS LIST

p1 Main path
p2, p3, p4 Delay path (delay wave)
10 Base station
11 Cell
12 Processor
13 Transmitter
20 Mobile station
21 Receiver
22 Processor
30 Reflective object
40 Main path
41 Delay path
50 Sampling section (FFT section)
52 Part of an immediately anterior OFDM symbol
101, 104, 107 Guard interval
102, 108 First valid symbol
103, 106, 109 Blank symbol
105 Second valid symbol
110 Sampling section (FFT section)
121 Modulation unit
122 IFFT unit
123 GI insertion unit
200 Mobile station
201 Main OFDM symbol
202 Delay OFDM symbol
203 Synthesized wave
204 Copied synthesized wave
205 Copied main OFDM symbol
206 Copied delay OFDM symbol
208 Section associated with a delay OFDM symbol
210 Receiver
220 Processor
221 GI elimination unit
222 FFT unit
223 Demodulation unit
224 Reception value control unit
301, 303 Duplicated valid symbol
302, 304 Cyclic prefix (CP)
305 Section associated with an N+1th symbol of a main path
400 Base station
410 Memory
420 Processor
430 Transmitter
510, 520 Base station
511, 521 Network interface
512, 522 Processor
513, 523 Transmitter
600 Base station
610 Transmitter
620 Processor
700 Base station
710 Processor
720 Transmitter
800 Mobile station
810 Receiver
820 Processor
910, 920, 930 Rotation phasor
940 Border vicinity of an anterior OFDM symbol
F1, F2, F3, F4, F5, f1, f2, f3, f4, f5 Subcarrier

1. A base station comprising:
a processor that
generates a first modulation symbol from transmission data,
converts the first modulation symbol from a frequency domain signal to a first valid symbol being a time domain signal by performing inverse Fourier transform for the first modulation symbol,
inserts a first guard interval into the first valid symbol, and outputs an inserted signal as a first orthogonal frequency division multiplexing (OFDM) symbol; and
a transmitter that transmits a first OFDM signal generated based on the first OFDM symbol, wherein
the processor
leaves blank at least one of
a second OFDM symbol adjacent to the first OFDM symbol or at least one of a plurality of subcarriers configuring the first valid symbol.

2. The base station according to claim 1, wherein
leaving the second OFDM symbol blank includes
not mapping transmission data into at least one of a plurality of subcarriers configuring the second OFDM symbol.

3. The base station according to claim 1, wherein
leaving the second OFDM symbol blank includes
configuring the second OFDM symbol in a same manner as the first OFDM symbol.

4. The base station according to claim 3, further comprising a memory that stores control information, wherein
the processor
determines whether the blank is set, based on the control information.

5. The base station according to claim 4, wherein,
when the control information
indicates that a delay time of a delay path relative to a main path where the first OFDM signal is transmitted in a multipath environment exceeds the first guard interval,
the processor
determines that the blank is set.

6. The base station according to claim 1, further comprising an interface that receives notification information from a second base station, wherein
the notification information
indicates that a fourth OFDM symbol adjacent to a third OFDM symbol configuring a third OFDM signal transmitted by the second base station is being left blank.

7. The base station according to claim 1, wherein
leaving blank at least one of a plurality of subcarriers configuring the first valid symbol includes
not mapping transmission data into a subcarrier where it becomes difficult to configure a sine wave of one cycle.

8. A mobile station comprising:
a receiver that receives a first orthogonal frequency division multiplexing (OFDM) signal generated based on a first OFDM symbol; and
a processor that
generates a first valid symbol by eliminating a first guard interval from the first OFDM symbol,
converts the first valid symbol being a time domain signal to a frequency domain signal by performing Fourier transform for the first valid symbol, and
generates transmission data by executing demodulation processing, based on the frequency domain signal, wherein
at least one of a second OFDM symbol adjacent to the first OFDM symbol or at least one of a plurality of subcarriers configuring the first valid symbol is blank.

9. The mobile station according to claim 8, wherein,
when the second OFDM symbol is blank,
transmission data are not mapped into at least one of a plurality of subcarriers configuring the second OFDM symbol.

10. The mobile station according to claim 8, wherein,
when the second OFDM symbol is blank,
the second OFDM symbol is configured in a same manner as the first OFDM symbol.

11. The mobile station according to claim 8, wherein,
when a delay time of a delay path relative to a main path where the first OFDM signal is transmitted in a multipath environment exceeds the first guard interval,
the second OFDM symbol adjacent to the first OFDM symbol is blank.

12. A control method for a base station, the method comprising:
generating a first modulation symbol from transmission data;
converting the first modulation symbol from a frequency domain signal to a first valid symbol being a time domain signal by performing inverse Fourier transform for the first modulation symbol;
inserting a first guard interval into the first valid symbol;
outputting an inserted signal as a first orthogonal frequency division multiplexing (OFDM) symbol;
transmitting a first OFDM signal generated based on the first OFDM symbol; and
leaving blank at least one of
a second OFDM symbol adjacent to the first OFDM symbol or at least one of a plurality of subcarriers configuring the first valid symbol.

13. The control method for the base station according to claim 12, wherein
leaving the second OFDM symbol blank includes
not mapping transmission data into at least one of a plurality of subcarriers configuring the second OFDM symbol.

14. The control method for the base station according to claim 12, wherein
leaving the second OFDM symbol blank includes
configuring the second OFDM symbol in a same manner as the first OFDM symbol.

15. The control method for the base station according to claim 14, the method further comprising:
storing control information; and
determining whether the blank is set, based on the control information.

16. The control method for the base station according to claim 15, the method further comprising
determining that the blank is set
when the control information
indicates that a delay time of a delay path relative to a main path where the first OFDM signal is transmitted in a multipath environment exceeds the first guard interval.

17. The control method for the base station according to claim 12, the method further comprising
receiving notification information from a second base station, wherein
the notification information
indicates that a fourth OFDM symbol adjacent to a third OFDM symbol configuring a third OFDM signal transmitted by the second base station is being left blank.

18. The control method for the base station according to claim 12, wherein
leaving blank at least one of a plurality of subcarriers configuring the first valid symbol includes
not mapping transmission data into a subcarrier where it becomes difficult to configure a sine wave of one cycle.

19-36. (canceled)
